(19) United States
(12) Patent Application Publication
(10) Pub. No.: US 2015/0282061 A1
(43) Pub. Date: Oct. 1, 2015

(54) SYSTEMS AND METHODS FOR COMMUNICATION ACROSS MULTIPLE COMMUNICATIONS NETWORKS

(71) Applicant: AWARE 360 Ltd., Calgary (CA)

(72) Inventors: Steven Gregory MATTHEWS, Calgary (CA); Donald Douglas Lafont, Calgary (CA); James Frederick McLellan, Calgary (CA)

(21) Appl. No.: 14/675,150

(22) Filed: Mar. 31, 2015

Related U.S. Application Data
(60) Provisional application No. 61/972,953, filed on Mar. 31, 2014.

(51) Int. Cl. H04W 48/18; H04W 76/00; H04W 4/00; H04W 24/08; H04W 4/22; H04W 4/04

(52) U.S. Cl. CPC H04W 48/18; H04W 4/22; H04W 4/046; H04W 4/008; H04W 24/08; H04W 76/007; H04W 80/06

(57) ABSTRACT

A network for providing mobile personnel safety status includes a safety pendant including hardware configured to provide pendant communication modes for transmitting a status message. A most costly pendant communication mode is selected when no other communication mode is available and a least costly pendant communication mode is selected whenever it is available. A messaging proxy device has hardware configured to provide one or more proxy communication modes for transmitting the status message. If the messaging proxy device provides more than one proxy communication mode, the messaging proxy device includes an algorithm for prioritizing the proxy communication modes according to availability and cost of transmission with selection of the most costly proxy communication mode when no other proxy communication mode is available and selection of the least costly proxy communication mode whenever it is available. A central monitoring station receives the status message transmitted from the messaging proxy device.

### CROSS REFERENCE TO RELATED APPLICATIONS

This application claims priority from U.S. Provisional Application Ser. No. 61/972,953 filed Mar. 31, 2014 and U.S. Provisional Patent Application Ser. No. 62/082,189 filed Nov. 20, 2014, the entire disclosures of which are incorporated herein by reference.

### FIELD OF THE INVENTION

The invention relates to systems and methods for providing communication across multiple communication networks. In particular, the invention relates to safety devices that can keep remote workers connected and able to both see and indicate their status to a monitoring station, using the most effective of radio, Ethernet, Wi-Fi, cellular and satellite data networks, in a variety of work areas and situations.

### BACKGROUND OF THE INVENTION

Systems enabling individuals and equipment located within an area to be monitored as they move within a particular area are well known. That is, various types of monitoring equipment with the capability to report a user's position to a central location are used for a variety of purposes including business efficiency, personnel safety and security and communication. Typically, such equipment will utilize a particular communication methodology that enables the equipment to operate within typically one or more types of networks. For example, smartphones enable long distance communication using a cellular network, and local communication using Wi-Fi and Bluetooth technologies. Another example is an iridium satellite device, which uses a communications satellite for long distance communication and may have local communication using Bluetooth.

While such systems are extremely powerful in terms of being able to receive and communicate data, systems such as smartphones have many limitations when used as emergency devices or emergency notification systems.

For example, in various applications actual field use may require that multiple devices be used, for various reasons. For example, a user may carry a combination of smartphone, a safety pendant (sometimes known as a “man down” pendant), a satellite communications device, and other systems to enable communication within remote or high-risk working scenarios.

While the use of multiple devices may be effective, there are numerous limitations to this approach and in certain applications, excessive or un-needed functionality is incorporated that may actually lead to decreased effectiveness under certain operations. As an example, in deployments where user safety or security is important, the complexity of using multiple devices including a voice device may decrease the effectiveness of communication where the objective of communication is safety and security and where the speed of communication is important.

For example, most monitoring stations are not easily able to track a single user with multiple devices. Also, systems enabling voice communications require very high bandwidth, which limits the coverage areas, and creates long connection wait times which are not practical in certain security and high-risk circumstances.

Further still, voice devices typically do not incorporate automatic check-in, and thus are limited in being able to report a “man down” situation or a situation in which a worker is incapacitated. Voice devices also require a number of steps to activate which may not be possible in the event of accident or attack. Such devices may also be subject to local laws that prevent the use of devices while operating a vehicle or machinery.

As a result of these limitations, voice devices are increasingly unacceptable as primary tools for safety and security applications in an increasing number of jurisdictions.

Further still, various jurisdictions are also increasing their requirements for automated systems for slip, trip, fall or no-motion outcomes.

Many data devices are one-way only. This means that the user is not informed if a reported emergency has been received and is being acted upon. This also creates a very high level of false alarms with many of the lone worker systems currently available. As noted above, there are a number of different types of devices that allow various forms of data/voice communication over different networks for safety and security applications. One class of devices, generally referred to as “safety pendants” includes devices that are designed to be worn by a user over or under clothing and that provide a link to a monitoring station. These pendants may be “cellular-only” pendants, “satellite-only” pendants, voice pendants, radio voice and data devices, each of which may individually perform various functions that are similar or different amongst different devices. However, these devices typically do not use more than one mode of communication per device, which limits the ability of these devices to connect to different networks using multiple modes of communication as may be required, particularly when a user is moving. As a result, in these cases, and as noted above, users are then forced to either carry multiple devices, or use very expensive satellite devices when they are not always required. In addition, these devices may require the user to set manual check-in protocols relying on timed intervals, where no communication is possible in the interval. Further still, such devices may be limited particularly when a user is moving between areas that may or may not be able to communicate through different media.

In summary, the typical communication systems and their limitations are shown in Table 1.

TABLE 1
Limitations of Communication Systems

| Communication | Type | Limitations |
|---|---|---|
| Voice only | cell phone | no “man down” |
| | or satellite | notification or timed |
| | | check-ins |
| | | requires that user is |
| | | not incapacitated |
| | | In case of satellite - |
| | | requires user to be |
| | | outside |
| Data device | smartphone | does not work |
| | application | outside cell range |
| | or cellular | may be one-way |
| | pendant | only or email only |
| | | notifications |
| Data device | Satellite | may be one way |
| | only | only with no |
| | | connection to two- |
| | | way monitor |
| | | requires user to be |
| | | outside |

As such, the limitations are generally related to the choice of underlying communications technology wherein, for a particular operating scenario, cellular-only devices, radio devices, and satellite-only devices are chosen to permit communications between workers and a monitoring center.

As a result, there has been a need for systems that expand the functionality of safety pendants and particularly systems that can utilize multiple communications technologies in one device such that the range and simplicity of use can be increased.

In addition, there is a need for “two-way” communications systems such that user is aware that their status in known by the central monitoring station and appropriate action is being taken, and that can provide accurate location information of the device when required. Further still, there has been a need for systems that provide automatic “man down” functionality within different communication systems.

US Patent Publication No. 20140225730 to DePascale describes a wearable personal locator device with a removal indicator. The device has a GPS tracking unit for communication with a ground-based network and sensors for body heat and/or pressure to determine if the device is removed from the user. A primary use of the device is for tracking lost children.

U.S. Patent Publication No. 20130293378 to Aninye et al. describes a monitoring system with a wireless tracking device and an administrative hub with a location database including speed limit data, for comparing speed to speed limit data. The device may be worn by an individual or installed in a vehicle. The hub has a database with a set of prescribed rules applicable to the device, for example, obeying a speed limit. Communication modes including wireless, cellular and RF signals are described.

U.S. Patent Publication No. 20120086574 to Blumel et al. describes a tracking system with a geographic locator such as GPS, global system for mobile communications (GSM), general packet radio service (GPRS) or wireless local area network (WLAN) or a combination thereof designed for tracking individuals, animals or objects.

U.S. Patent Publication No. 20120223834 to Hyatt describes a device for tracking children in the form of a watch with locating circuitry such as a GPS receiver or cell phone locator, as well as communication circuitry such as cell phone, radiofrequency, Bluetooth or other wireless transmission circuitry. Health monitoring circuitry is included for measuring heart rate, blood pressure, temperature, blood sugar and stress. A panic or help button is also included for the purpose of signaling for assistance. Information is relayed to a cell tower in communication with a central server which is equipped to monitor thousands of such tracking devices. The identification of the individual wearing the device is stored in the server and associated with the tracking device. Health information, contact information, and historical information are all stored on the server and associated with that individual's tracking device.

U.S. Patent Publication No. 20100141393 to Daniel describes a system and method for group tracking based on a device designed for attachment to footwear. The wireless tracking device is configured for bi-directional communications with a monitoring center, wherein the wireless tracking device is adapted to determine and store absolute location information of the individual wearing the wireless tracking device and the location information of at least one other individual within the tracked group. Each individual's tracking device has a unique identifier for identifying the individual with a monitoring center at a remote location and/or portable monitoring unit. The device is provided with a means for transmitting an encrypted signal containing location information which is a short range wireless protocol including one or more of WiHLoN.™, ZigBee, Bluetooth.®, 802.11 series, or any other short range wireless protocol that is well known and used in the arts. Each device in the system is provided with a means for communicating information to a monitoring center over a satellite network system. If a given device does not have direct access to the satellite network system the encrypted signal containing individual's location information is transmitted from that device to each neighboring wireless tracking device until a device is located with direct access to the satellite network system. If direct access cannot be found, the device will cease its query and retain the location information for future transmission.

U.S. Patent Publication No. 20090201201 to Foster describes a tracking system for individuals, varying types of vehicles, or devices, such as individual consumers, airplanes, service and emergency vehicles, service and military personnel, packages, suitcases and such other objects to be tracked. The system comprises a central office that interactively communicates with various portable tracking units over at least two communication networks. The multiple communication networks help to maintain a connection with the tracking units. The central office can also actively manage the information provided a user of the tracking unit. This allows the central office to change the route of the user based on changing conditions. The multimode communication system may include GPS, cellular, satellite or radio communication modes. For example, in the preferred embodiment, the communication networks comprise a cellular communication network as the primary network and a satellite communication network as a secondary network. When the tracking unit is out of range of the cellular communication network, the tracking unit can generally communicate over the satellite communication network.

U.S. Reissue Pats. RE41,122 and RE41,102 to Jamel et al. are reissued from the same original patent U.S. Pat. No. 6,788,200 and describe a locator unit contained within footwear providing a method for GPS position determination and transmission of said location determination data to a central monitoring station which disseminates the data through the use of proprietary software, wireless communications, land based wire systems and the Internet. Communications equipment used in conjunction with the device can include PDA, laptop, computer, or phone using communications medium satellite technology, wireless technology, cellular technology, technology using radio waves and technology using air waves.

U.S. Pat. No. 8,665,087 to Greene describes wearable portable sensors for establishing interoperable communications and an incident site in a temporary incident area network which allows responders of varying origin to be provided with a common communications link, for example, the 802.11 protocol or Bluetooth.

U.S. Pat. No. 8,718,935 to Miller et al. describes a navigational initialization system, process, and arrangement. The system includes the combination of inertial sensor devices and a communication device, both of which are wearable by the subject of the navigation and/or tracking operations of the system. The system includes a means for identifying individual devices being tracked.

U.S. Patent Publication No. 20140225730 to DePascale et al. describes a wearable personal locator device with a removal indicator. The device has a GPS tracking unit for communication with a ground-based network and sensors for body heat and/or pressure to determine if the device is removed from the user. It is described that a primary use of the device is for tracking lost children. An input terminal allows an administrator to monitor the location of the wearable locator devices. An interface layer is provided on the input terminal, which allows the user to log on using a registered log-in to register the wearable locator device to the specific user.

U.S. Pat. No. 7,373,109 to Pohja et al. describes a system and method for registering or otherwise associating items with generated content. In one embodiment, images, video, audio, or other media/multimedia content is generated, and the items and/or people present and relevant to the creation of that content are determined. A record of those relevant items and/or people may then be associated with that created content, so that the content includes a record of who/what was there when the content was created. In one example, digital content is created at a mobile device. A query signal is transmitted from the mobile device to entities within a wireless transmission range of the mobile device. The mobile device receives identifiers from the entities in response to the entities successfully receiving the query signal. The received identifiers are digitally associated with the digital content created at the mobile device. Query signals may include Bluetooth query signals, WLAN query signals, RFID signals, etc.

U.S. Patent Publication 20140159879 and U.S. Pat. No. 7,250,854 to Rezvani et al. describe an automatic registration system for registration of monitoring modules that communicate with remote sites. Devices at one or more locations may interface with the monitoring modules. Devices may include, for example, video cameras, still cameras, motion sensors, audible detectors, any suitable household appliances, or any other suitable device. Monitoring modules may be stand-alone devices, software applications, any suitable combination of software and hardware, or any other suitable architecture. Monitoring modules may communicate with one or more remote sites via a suitable communications network using any suitable communications protocol. The monitoring modules and remote sites may use a registration protocol to transmit registration information. The registration information may get stored in a database at the remote site. The registration protocol may be a subset of the communications protocol used between the monitoring modules and the remote sites.

U.S. Patent Publication 20080077326 to Funk et al. describes a method and system for locating and monitoring first responders. The system includes a portable module couple to a data transceiver. The portable module has an inertial navigational unit equipped with an accelerometer. The system has a base station for receiving position information from the portable module. The base station software can provide an interface where an incident commander or other operator type personnel (operator) can monitor the location and vital signs of people, animals or assets that are carrying the portable module. The base station software has the ability to maintain, process, display and edit a personnel database. This database can be physically stored: locally, on a remote server, or a portable memory device, or any combination of all three. This database can be created over time and compiled together to be shared with any user of the base station software. Personal information may be included in the database.

U.S. Patent Publication 20060155584 to Aggarwal describes a system and method for uniquely identifying each patient, monitoring, tracking and rescue, when admitted to any hospital, nursing home or health care providing facility. The patient identification is done by issue of a Unique Patient Identification Number (PIN). Patient monitoring is done by collection of critical parameters and comparison with a reference scale. Patient tracking is achieved by integration of the software with a suitable transmission/reception system and patient-wearable tracking device.

Accordingly, there has been a need for safety devices and systems which can keep remote workers connected to a central monitoring station and able to both see and indicate their status, using the most effective of radio, cellular and satellite data networks, for the users in a variety of work areas where the availability of certain modes of communication may be limited.

### SUMMARY OF THE INVENTION

One aspect of the present invention provides a network for providing mobile personnel safety status, the network comprising: a) a safety pendant including hardware configured to provide a plurality of pendant communication modes for transmitting a status message, wherein the most costly pendant communication mode is selected when no other communication mode is available and wherein the least costly pendant communication mode is selected whenever it is available; b) a messaging proxy device including hardware configured to provide one or more proxy communication modes for transmitting the status message, wherein, if the messaging proxy device provides more than one proxy communication mode, the messaging proxy device includes an algorithm for prioritizing the proxy communication modes according to availability and cost of transmission with selection of the most costly proxy communication mode when no other proxy communication mode is available and selection of the least costly proxy communication mode whenever it is available; and c) a central monitoring station for receiving the status message transmitted from the messaging proxy device.

In some embodiments, the messaging proxy device is a smartphone which is connectable to a cellular network as the only proxy communication mode used for transmitting the status message to the central monitoring station.

In some embodiments, the messaging proxy device is a wireless asset management (WAM) hub which is configured to provide a plurality of proxy communication modes for transmitting the status message to the central monitoring station.

In some embodiments, the plurality of proxy communication modes includes two or more of a satellite communication mode, a cellular communication mode, an Ethernet communication mode and a Wi-Fi communication mode.

In some embodiments, the messaging proxy device is located in and operated from a vehicle.

In some embodiments, the pendant communication modes include any combination of two or more of: Bluetooth, Ethernet, access point Wi-Fi, radio, cellular and satellite communication modes.

In some embodiments, the pendant communication modes are Bluetooth and radio communication modes.

In some embodiments, the radio communication mode is ZigBee radio.

In some embodiments, the safety pendant includes a GPS or GLONASS receiver, or both, and the status message includes safety pendant location information, determined by the GPS or GLONASS receiver or both.

In some embodiments, the safety pendant includes a gyrometer and the status message includes safety pendant orientation information determined by the gyrometer.

In some embodiments, the safety pendant includes an accelerometer and the status message includes safety pendant acceleration information determined by the accelerometer.

In some embodiments, the messaging proxy device includes a data storage module and a processor configured to store low priority messages in the data storage module for later transmission when a lower-cost communication mode becomes available.

In some embodiments, the network is configured for two-way communication between the safety pendant and the central monitoring station via the messaging proxy device.

Another aspect of the invention is a network for monitoring equipment or vehicles, the network comprising: a) a messaging proxy device including hardware configured to provide one or more proxy communication modes for transmitting a status message based on data received from the equipment or vehicles, wherein the messaging proxy device includes an algorithm for prioritizing the proxy communication modes according to availability and cost of transmission with selection of the most costly proxy communication mode when no other proxy communication mode is available and selection of the least costly proxy communication mode whenever it is available; and b) a central monitoring station for receiving the status message transmitted from the messaging proxy device.

In some embodiments, the messaging proxy device is a wireless asset management (WAM) hub which is configured to provide a plurality of proxy communication modes for transmitting the status message to the central monitoring station.

In some embodiments, the plurality of proxy communication modes includes two or more of a satellite communication mode, a cellular communication mode, an Ethernet communication mode and a Wi-Fi communication mode.

In some embodiments, the messaging proxy device is located in and operated from a vehicle.

In some embodiments, the network further comprises a safety pendant including hardware configured to provide a plurality of pendant communication modes for transmitting a status message, wherein the most costly pendant communication mode is selected when no other communication mode is available and wherein the least costly pendant communication mode is selected whenever it is available.

the pendant communication modes include any combination of two or more of: Bluetooth, Ethernet, access point Wi-Fi, radio, cellular and satellite communication modes.

In some embodiments, the pendant communication modes are Bluetooth and a radio communication mode.

In some embodiments, the radio communication mode is ZigBee radio.

In some embodiments, the safety pendant includes a GPS or GLONASS receiver, or both, and the status message includes safety pendant location information, determined by the GPS or GLONASS receiver or both.

In some embodiments, the safety pendant includes a gyrometer and the status message includes safety pendant orientation information determined by the gyrometer.

In some embodiments, the safety pendant includes an accelerometer and the status message includes safety pendant acceleration information determined by the accelerometer.

In some embodiments, the messaging proxy device includes a data storage module and a processor configured to store low priority messages in the data storage module for later transmission when a lower-cost communication mode becomes available.

In some embodiments, the network is configured for two-way communication between the safety pendant and the central monitoring station via the messaging proxy device.

In some embodiments, the algorithm for prioritizing the proxy communication modes is re-programmable by a programmer when remotely connected to the messaging proxy device.

Another aspect of the present invention is a safety pendant for providing mobile personnel status, the safety pendant comprising: a) hardware configured to provide a plurality of communication modes; b) a user interface configured to allow input of a plurality of status states and to display messages transmitted from a central monitoring station; and c) a processor configured to select a pendant communication mode from the plurality of communication modes based on availability and cost wherein the most costly pendant communication mode is selected when no other pendant communication mode is available and wherein the least costly pendant communication mode is selected whenever it is available.

In some embodiments, the pendant communication modes include any combination of two or more of: Bluetooth, Wi-Fi, Ethernet, radio, cellular and satellite communication modes.

In some embodiments, the pendant communication modes are Bluetooth and radio communication modes.

In some embodiments, the radio communication mode is ZigBee radio.

In some embodiments, the safety pendant further includes a GPS or GLONASS receiver, or both, and the status message includes safety pendant location information, determined by the GPS or GLONASS receiver or both.

In some embodiments, the safety pendant includes a gyrometer and the status states include safety pendant orientation information determined by the gyrometer.

In some embodiments, the safety pendant includes an accelerometer and the status states include safety pendant acceleration information determined by the accelerometer.

Another aspect of the present invention is a mobile communication device comprising: a) hardware configured to provide at least one communication mode; b) a user interface configured to allow input of a plurality of status states and to display messages transmitted from a central monitoring station; and c) a scannable code for linking a unique identifier of the safety pendant to a website for use in registering the safety pendant to an individual user.

In some embodiments, the communication mode is a one-way communication mode or a two-way communication mode.

In some embodiments, the scannable code is a quick response (QR) code or a bar code.

In some embodiments, the scannable code is a QR code.

In some embodiments, the communication mode is a cellular communication mode, a radio communication mode, a Wi-Fi communication mode, an Ethernet communication mode or a satellite communication mode.

In some embodiments, the radio communication mode is ZigBee.

In some embodiments, the scannable code is protected by a transparent plastic cover.

In some embodiments, the scannable code includes metadata for providing a connection to an individual device-specific web page.

In some embodiments, the device further comprises a GPS or GLONASS receiver, or both.

Another aspect of the present invention is a network for providing mobile personnel safety status, the network comprising: a) one or more mobile communication devices as described herein; b) a messaging proxy device; and c) a central monitoring station for receiving the status message transmitted from the messaging proxy device.

In some embodiments, the website provides fields for entry of user information including one or more of: a user name, a vehicle plate number registered to a user, and a mobile telephone number registered to a user, the user information used to register a user to an individual safety pendant of the one or more safety pendants.

In some embodiments, the central monitoring station is linkable to the website for transfer of pendant registration information to the central monitoring station.

In some embodiments, the central monitoring station is linkable to medical information about individual registered users, and/or linkable to emergency contact information.

Another aspect of the present invention is a method for registering an individual user to an individual mobile communication device, the method comprising: a) providing the individual mobile communication device with a unique identifier and a scannable code corresponding to the unique identifier, wherein the scannable code, when scanned with a mobile computing device, opens a website corresponding to the individual mobile communication device; and b) entering information of the individual user on the website, thereby registering the user to the individual mobile communication device.

In some embodiments, the mobile communication device comprises: i) hardware configured to provide at least one communication mode; and ii) a user interface configured to allow input of a plurality of status states and to display messages transmitted from a central monitoring station.

In some embodiments, the website provides fields for entry of user information including one or more of: a user name of the individual user, a unique identifier, a vehicle plate number registered to the individual user, and a mobile telephone number registered to the individual user.

In some embodiments, the method further comprises the step of querying the website and downloading user registration information to the central monitoring station.

In some embodiments, the method further comprises the step of providing a means for the central monitoring station to access medical information and/or emergency contact information of the individual registered user.

In some embodiments, the unique identifier is a serial number.

In some embodiments, the scannable code is a QR code or a bar code.

In some embodiments, the communication mode is a cellular communication mode, a radio communication mode, or a satellite communication mode.

In some embodiments, the radio communication mode is ZigBee.

In some embodiments, the scannable code includes metadata for providing a connection to an individual device-specific web page.

### BRIEF DESCRIPTION OF THE DRAWINGS

The invention is described with reference to the accompanying figures in which:

FIG. 1 is a schematic overview of a networked safety pendant 10 in accordance with one embodiment of the invention. The drawing shows changes in the network composition as the safety pendant moves to a number of different locations (A to H) with transmission of communications by a smartphone 14 (via Bluetooth), a stationary messaging proxy device 16, and a mobile messaging proxy device 18. An example of an intermediate relay via a radio (ZigBee) mesh network includes a second safety pendant 20 at position F. Communications are sent to and from a central monitoring station 12.

FIG. 2A is a schematic overview of a network of four safety pendants with one carried by each worker W-1 to W-4 working on a 4-square kilometer grid with one worker in each quadrant. The mobile messaging proxy device 18 is located on the border between the two left quadrants and approaching the center of the grid.

FIG. 2B is a schematic overview of a network of four safety pendants with one carried by each worker W-1 to W-4 working on a 4-square kilometer grid with one worker in each quadrant. The mobile messaging proxy 18 is located on the border between the two right quadrants and moving away from the center of the grid.

FIG. 2C is a schematic overview of a network of four safety pendants with one carried by each worker W-1 to W-4 working on a 4-square kilometer grid with one worker in each quadrant. The mobile messaging proxy 18 is located on the border between the two right quadrants and moving further away from the center of the grid than its position shown in FIG. 2B. In addition, worker W-1 is in distress and has transmitted an SOS signal to the mobile messaging proxy 18.

FIG. 3 is a schematic overview of a process for registering a safety pendant 10 having a unique identifier (001) and a QR code 62 to an individual user using a QR code scanner on a smartphone 14 which links the safety pendant 10 to a safety pendant registration website 70 displayed on the smartphone 14.

FIG. 4 is a schematic illustration of how registration of a safety pendant (001) to worker W-1 can facilitate the rescue and provide informed medical treatment.

FIG. 5 is a schematic illustration of a plurality of stationary proxy devices 16a, 16b and 16c connected via an ethernet network and in communication with a central monitoring station 12 via an internet connection.

FIG. 6 is a schematic illustration of a plurality of stationary proxy devices 16a, 16b and 16c connected via an ethernet network and in communication with a central monitoring station 12 via a cellular network.

FIG. 7 is a schematic illustration of a plurality of stationary proxy devices 16a, 16b and 16c connected via an ethernet network and in communication with a central monitoring station 12 via a satellite communication network.

### DETAILED DESCRIPTION OF THE INVENTION

### Overview

A network system and a device for use with the network system are described. Components of the network are particularly effective for data collection and communication in relation to user safety and user location. A user in the context of this description is a generally a single person and/or a team or group of people and that may be associated with particular machinery including vehicles or the like. The main network components include at least a safety pendant, a data collection and transmission messaging proxy device and a central monitoring station. Additionally, the network may include a smartphone and/or additional one-way or two-way communication devices carried by individual users, each of which is configured with the requisite hardware and software for communication with the messaging proxy device and/or other devices in the network. The features of the network and safety pendant are described hereinbelow.

A number of alternative embodiments are briefly discussed in context of certain example embodiments. It is to be understood that the features of various alternative embodiments may be included in various combinations by the skilled person and that these combinations represent further embodiments understood by the skilled person to be within the scope of the invention.

### General Features of the Safety Pendant, Messaging Proxy Device and Monitoring Station

The safety pendant includes an input and output interface enabling a user to input data and receive data from the monitoring station and to provide information to the user about the status of the device (such as battery status, connection to networks, and the like). The device is configured for input of data by the user. Such data may represent an SOS signal or simply provide a message to the central monitoring station to confirm that the user is desirous of being monitored (check-in), or no longer requires monitoring (check-out). Upon receipt of messages from the safety pendant the central monitoring station will generally send a confirmation message back to the safety pendant to indicate that a message has been received. For example, a confirmation may indicate that an SOS signal has been received and that assistance has been dispatched to the user's location. In addition, messages transmitted by the central monitoring unit to the safety pendant may include an emergency signal and/or instructions to the user to undertake active retreat or evasive action.

In certain embodiments, the user interface will include a vibration module and a light communication system that enables a user to receive communications from one or more central locations and also initiate communication back to one or more central locations.

The pendant will preferably include a series of signals that are easily interpreted by a user. In one embodiment, the system includes:

a. A red light indicator—failure status:
i. Indicates that the device is not operating correctly (e.g. there is no link to the central monitoring station) or indicates an SOS, or an emergency or dangerous situation

b. A yellow light indicator—caution status:
i. Indicates that the device is partially operational or in a transiting state

c. A green light indicator—good status
i. Indicates that the device is operating correctly, and connected to the central monitoring station, and/or there is no emergency or dangerous situation

d. Flashing Lights
i. Quick red flash—indicates that the device is sending an SOS message to the central monitoring station—the red flash changes to solid when the central monitoring station acknowledges receipt
ii. Quick green flash—indicates that a “cancel SOS” message has been sent by the user—the green flash changes to solid when the Monitor acknowledges status change
iii. Bar graph—Level Indication
   1. Slow flash strobing up—indicates that the battery level is charging when device is plugged in
   2. Solid—indicates battery level when the device is unplugged

In another embodiment, there are two sets of LED indicator lights. The LEDs on the bottom indicate connectivity to monitor, battery level and charging status. The lights on the top indicate monitor status, including “checking in,” “checking out,” “SOS” and “cancel SOS.”

The skilled person will appreciate that these indicators are examples and other possible indicator codes represented by various other combinations of flashing colored lights may be incorporated into different safety pendant embodiments.

In certain embodiments, the user interface includes an emergency button. In one embodiment, during operation of the safety pendant, the user will depress an emergency for a prolonged period (e.g. greater than 3 seconds) which will initiate an emergency signal which is transmitted to the monitoring station. Initially, at the time that the emergency signal is being transmitted but is not acknowledged as being received, the system will provide one unique signal visible to the user. When the message has been received by the central monitoring station, a message will be transmitted to the pendant indicating via another unique signal visible to the user that the emergency signal has been received. Finally, a third signal visible to the user will be initiated within the device when it receives a message from the central monitoring station indicating that a rescue operation has been initiated. Signals sent to the safety pendant may be in the form of light, buzzers and vibrations in various combinations. As such, the user is always aware of his status as perceived by the monitoring center.

Similarly, in the event of the need to communicate a message to the user of an emergency or dangerous situation, the central monitoring station can send a unique emergency or danger signal to the user's pendant.

### Data Communication

Generally, when reporting pendant data, each pendant will transmit location and status to the central monitoring station. Location data is obtained by each pendant using a GPS and/or GLONASS receiver, or a combination of these two modes, with location averaging performed according to known procedures. Status data is provided by functionality hardware/software. When prompted for this information or on a time-based reporting protocol, this information will be transmitted to the central monitoring station. In certain scenarios, GPS/GLONASS position data will not be available but status data will be in which case, status data only would be reported, including the pre-programmed location of the mobile messaging proxy device, so that the central monitoring station at least has information about the general zone of the user of the pendant.

In an alternative embodiment, a safety pendant includes each of a Wi-Fi modem,

ZigBee radio modem, a Bluetooth modem, a GPS/GLONASS receiver as well as cellular and satellite modem chipsets operatively connected to a user interface module. It should be noted that not all of the above will be included in that in certain embodiments such as the embodiment described in the examples hereinbelow, the pendant will not itself have cellular and satellite communication capabilities, but will have the requisite hardware for communication with the central monitoring station through Wi-Fi/Bluetooth and short range radio through a distinct messaging proxy device having the cellular/satellite capabilities, or through Bluetooth linked to a smartphone which is connected to a cellular network. Connection to a messaging proxy device also will make connection to the internet via an Ethernet or Wi-Fi access point as well, in certain scenarios, such as when the messaging proxy device is a stationary device inside a building, for example.

The pendant may also include other sensors for reporting user status including a gyrometer, an accelerometer and other sensors that may be used to report specific data about user status. For example, a gyrometer can report the orientation of a safety pendant (e.g. horizontal vs. vertical) and an accelerometer could be used to report impact or force data on the safety pendant. Such data may be helpful in events where a user is rendered unconscious in an accident.

### Communication Protocol

In one embodiment, the safety pendant incorporates four modes of RF communication methods (cellular, iridium satellite data, Wi-Fi—802.11 host and client, and ZigBee radio) into one platform, and uses a configurable data handling set of algorithms to store and forward collected data according to a priority sequence determined in a configuration settings table. This allows data conduit transmission costs to be managed dynamically based on a set of configurable rules, without limiting the amount of data collected stored for later transmission. The devices also support two-way communication using all modes of communication, allowing “over-the air” configuration changes and updates, and operational communications between service users and remote devices.

In one embodiment, utilizing two-way communication with the pendant accomplishes two advantages; first, it allows the user to received clear confirmation of responses to actions generated by the user from the remote monitor center; secondly, it allows the alert state of the pendant to be synchronized with the state of the monitor center responses whenever communication between the pendant and the monitor center transition from one type to another or the communications become temporarily unavailable and reconnect. The central monitoring station can also trigger alerts on multiple pendants. In one example, the central monitoring station receives a notification from an outside source that a forest fire is approaching the location of the pendant users. The central monitoring station will then trigger an “SOS” alert status on each of the pendants which are carried by workers at that general location.

In certain embodiments, several hardware data interface standards are incorporated into the platform which includes RS232, RS485, CANBUS, USB, and Ethernet 10/100. In certain embodiments, internal non-volatile storage expansion is facilitated by use of an on-board USB Disk On Module (DOM). External peripheral and storage expansion is possible facilitating the USB 2.0 interface ports on the platform.

In certain embodiments, position information is collected using inputs from both GPS and Glonass systems concurrently, for precision positioning of moving assets and rapid acquisition of position fix on start-up. The GPS/Glonass input is also used to supply precise timing for each event (data point) collected.

In certain embodiments, data handling includes logic algorithms to match acceptable or predicted values against actual values and summarize outcomes into a succinct message for high priority event messaging outcomes, so that the message is suitable for short-burst-data transmissions in satellite network communications.

In certain embodiments, a data transmission algorithm incorporates a data prioritization table which allows all data collected to be selected and prioritized for transmission using weighted costing decision mapping. The algorithm identifies urgent message categories and sends these messages out immediately across all modes of communication. As messages decrease in urgency or importance, modes of communication are removed from the transmission request. Satellite, cellular, radio and lastly Wi-Fi are dropped from the transmission request in that order.

The data transmission algorithm also supports the possibility of a “no-transmission” outcome where data in that category is to be stored and never communicated. This data can only be downloaded manually using USB download. This function would typically be used if the data group is too large for practical transmission over intermittent connections or if security of data may be an issue.

For the cellular network, the safety pendant has firmware which will connect via Bluetooth to a cellular smartphone application, and which will allow messages to be sent over the cellular data network. The pendant links to the smartphone via Bluetooth, and the smartphone then transmits the status of the safety pendant to the central monitoring station.

For the satellite network, the pendant connects to devices which have ZigBee radio or Bluetooth modems, as well as iridium satellite modems. In this case, the pendant sends out messages in a format which is then packetized for transmission over the Iridium satellite data network. The pendant can receive messages from the satellite data network.

### Assignment of Safety Pendants to Various Users

In certain situations, the safety pendants described herein are used by workgroups in the field and returned to a central location when the work is complete. It is advantageous to provide the safety pendants with a convenient means for registering a safety pendant to an individual user as well as de-registering a pendant from a first individual user and registering it to additional users in the future (for example, during a change in shift when one worker is replaced by another worker). The present invention includes a safety pendant with a convenient means for performing such registration and de-registration of a first user and registration/de-registration of subsequent users.

The safety pendant is assigned a unique identifier such as a serial number or other means of unique identification. This unique identifier is linked to a unique internet URL (website) with field entries for registration of the safety pendant. The safety pendant includes a scannable code which is linked to the website. By simply scanning the code on the pendant using a scanning application operable from a portable computing device such as a tablet or a smartphone, the website corresponding to that safety pendant is opened on the portable computing device and the user may then add identifying information (including a unique identifier of an individual such as name, call sign, badge number, e-mail address, vehicle plate number, mobile telephone number, or any other unique user identifier) to the entry fields provided on the website. Upon confirmation, the user is registered to the pendant. In certain embodiments, this registration information is updated at the central monitoring station by an automated registration query update performed by the central monitoring station. In certain embodiments, the website for an individual pendant is password protected.

The scannable code may be a quick response (QR) code or a bar code, or any other code with similar capabilities. In certain embodiments, the scannable code is protected with a transparent barrier such as tape or reinforced plastic to protect it from the harsh environmental conditions that may be encountered by workers.

In certain embodiments, when a specific pendant is registered to an individual user, the central monitoring station links the specific pendant to user-specific information such as emergency contact information as well as basic medical information about the user which may include medications currently in use, medication allergies, blood type, and any other medical information that may facilitate appropriate medical treatment in the event of an injury or adverse health event precipitated by an accident at a work site. In other embodiments, the emergency contact information and/or medical information may be entered by the user on the pendant's website or on a website linked to the pendant website. The entry of emergency and/or medical information may be required as a condition for completing the pendant registration process.

As a result of linking to medical information, for example, a worker is injured and uses his registered safety pendant to transmit an SOS message to the central server, the central server immediately dispatches a rescue and also has access to all the necessary information about the worker to facilitate medical treatment after the worker is rescued. This information can be easily conveyed to emergency medical technicians via available networks. Likewise, emergency contact information will be useful in order to notify family members of an accident.

### EXAMPLES

Certain aspects of the functionality of the safety pendant and network system are described in the following examples.

### Example 1

### A Variable Composition Network Including a Safety Pendant with Bluetooth and Short Range Radio Communication Modes

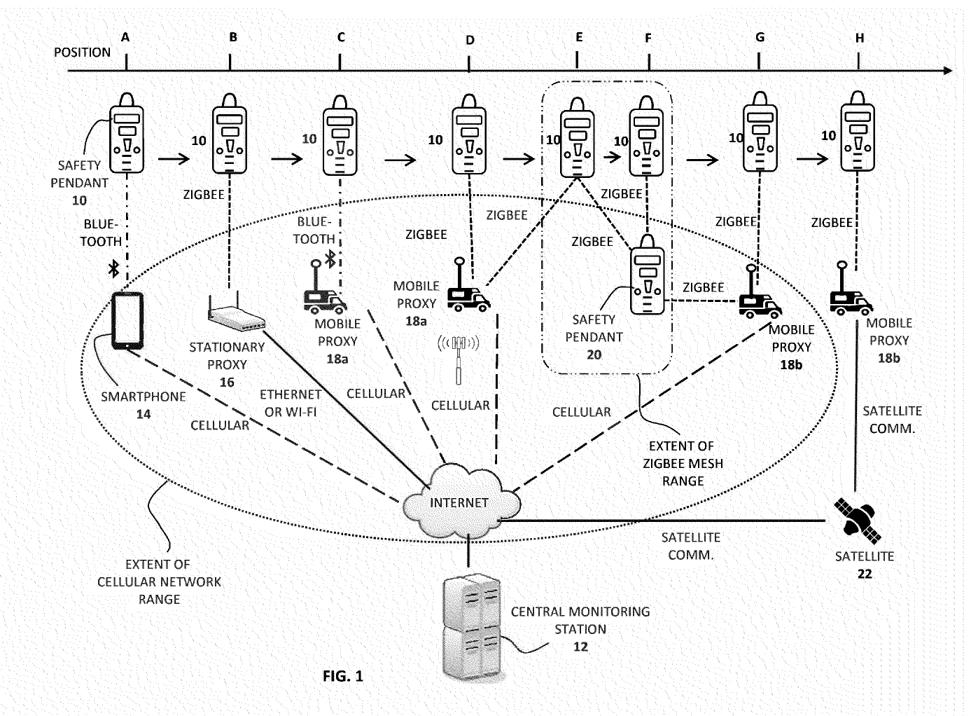

FIG. 1 is a schematic representation of a network system includes a safety pendant 10 that includes hardware and software enabling communication with different communications networks through a virtual private network (VPN) to a central monitoring station 12.

In this particular embodiment, the safety pendant 10 is configured for communication via Bluetooth (range of approximately 10 m) and ZigBee short range radio (range of approximately 1 km). Other wireless networking and short range radio systems may be used in alternative embodiments. It is to be understood that additional embodiments of safety pendants may be constructed which include the requisite hardware to enable them to directly connect to a cellular network or to a satellite network. However, inclusion of such hardware for these additional communication modes increases cost of the safety pendant device and such communication augmented devices would likely only be used in specific situations where it is challenging to strategically place suitable messaging proxy devices.

The system is designed to ensure that, depending on the user's environment, different communication systems are automatically activated to ensure that two-way communication is established between the user's safety pendant and the central monitoring station. Two-way communication is verified through a system that activates a user interface (e.g. LED lights on the pendant) that verifies that the pendant is linked to the central monitoring station.

In this particular example, a firefighter is wearing a safety pendant 10 when travelling to the fire station and then responding to a remote emergency at an industrial site outside a city and in a location with only intermittent cellular coverage. Each member of the firefighting team is wearing a similar pendant. However, for the sake of clarity, the present example will focus on a single firefighter wearing safety pendant 10.

In FIG. 1, at position A, the firefighter is at his home with his safety pendant 10 and getting ready for a shift at the fire station. He tests the Bluetooth connection of his safety pendant 10 with his personal smartphone 14 which has a smartphone application for connecting to the central monitoring station 12 via a cellular network and the internet and the digital display of the safety pendant 10 provides an indication that the safety pendant 10 has made a successful connection with to the central monitoring station 12.

The firefighter then arrives at the fire station at position B. The fire station has a wireless asset management (WAM) hub, acting as a stationary messaging proxy device 16. The stationary network messaging proxy device 16 transmits messages via a virtual private network (VPN). In this particular embodiment, the distance between the safety pendant 10 and the stationary messaging proxy device 16 is outside of Bluetooth range. The safety pendant 10 is programmed to switch on its ZigBee short-range radio upon loss of the Bluetooth connection. This allows the firefighter to test the ZigBee radio communication mode of his safety pendant 10. It is then verified that the ZigBee radio of the safety pendant has made a connection to the stationary messaging proxy device 16 which then connects to the central monitoring station 12 via an Ethernet connection or a Wi-Fi access point which is connected to the internet.

A fire is reported at a group of buildings at an industrial site. It is known that part of the site experiences only intermittent cellular network coverage. The firefighting team departs the station in a vehicle which includes a mobile network messaging proxy device 18a designed to collect, prioritize and transmit Bluetooth and ZigBee communications from safety pendants to the central monitoring station 12 either by a cellular network, or, in the absence of a cellular network, via a satellite network. As the firefighter enters the truck at position C, the safety pendant 10 drops its ZigBee communication with the stationary messaging proxy device 16 at the fire station and connects by Bluetooth to the mobile network messaging proxy device 18a and then to the central monitoring station 12 via a cellular network and the internet using a VPN. This selection of communication modes is prioritized by the processor of the safety pendant 10 according to the cost of each communication mode. It is thus to be understood that the safety pendant 10 would also connect automatically to the mobile network messaging proxy device 18a via ZigBee radio if the Bluetooth mode was switched off or not operating properly.

At position D the firefighter exits the truck and begins moving towards his objective at the industrial site. At a distance greater than about 10 m from the truck, the safety pendant 10 loses the Bluetooth connection which was previously established at position C. Loss of the Bluetooth connection triggers the processor of the safety pendant 10 to turn on its ZigBee radio transmitter and establish a ZigBee connection to the mobile messaging proxy device 18a and the central monitoring station 12 via the cellular network and the internet.

The firefighter receives a request to provide assistance to another team which is supported by a different truck with its own mobile messaging proxy device 18b. When the firefighter arrives at position E, he is within ZigBee range of both his original messaging proxy device 18a and the second messaging proxy device 18b of the other team, in a connection which is made via a second safety pendant 20 (carried by another firefighter) in a ZigBee connection network known in the art as a “ZigBee mesh.” As such, a mesh network may be established between a number of pendants within ZigBee range and an appropriate messaging proxy device.

At position F, the firefighter has moved further away from his original messaging proxy device 18a and the ZigBee connection with messaging proxy device 18a is lost. However, the connection with messaging proxy device 18b via the ZigBee mesh with safety pendant 20 is maintained and the safety pendant 10 remains connected to the central monitoring station 12 via the cellular network and the internet.

At position G, the firefighter has moved away from the other firefighter carrying safety pendant 20 and the ZigBee mesh network connection is lost. However, safety pendant 10 remains connected to the mobile messaging proxy 18b by virtue of being directly in ZigBee range and thereby connected to the central monitoring station 12 via the cellular network and the internet.

Finally, at position H, the firefighter carrying safety pendant 10 remains connected to messaging proxy device 18b by ZigBee. However, the truck carrying messaging proxy device 18b has moved to a position outside of cellular network range (as indicated by the dotted oval in FIG. 1). Messaging proxy device 18b is programmed to switch the mode of communication with the central monitoring station 12 in the event of loss of cellular network coverage. Therefore, messaging proxy device 18b connects to the satellite 22 and establishes satellite-based communication with the central monitoring station 12. As described above, the establishment of this different communication mode is accompanied by a verification message sent to safety pendant 10 from the central monitoring station 12.

In accordance with the above, a number of different operational scenarios can be established where different network components act in various combinations to maintain communications. It is to be understood that the different network components will be under the control of processor logic (on the pendant and the messaging proxy device) to seek the least expensive mode of communication when available and then move to more expensive modes if required. This order from least expensive to most expensive will generally be Wi-Fi/Bluetooth to short range radio (such as ZigBee) to cellular to satellite. Power consumption may also be factored into the decision-making algorithm which selects communication modes. An alternative network embodiment includes the use of a smartphone instead of a safety pendant. In such an alternative embodiment, the smartphone has Bluetooth and cellular communication modes for communicating with the messaging proxy device. A smartwatch may also be used to connect to the smartphone via Bluetooth. This combination is less conspicuous than a safety pendant and the use of a smartwatch would facilitate the process of initiating an emergency signal if the smartphone was stored in a pocket or in a holster of the user, for example.

### Example 2

### Monitoring of Four Workers at a Work Site Using a Variable Composition Network

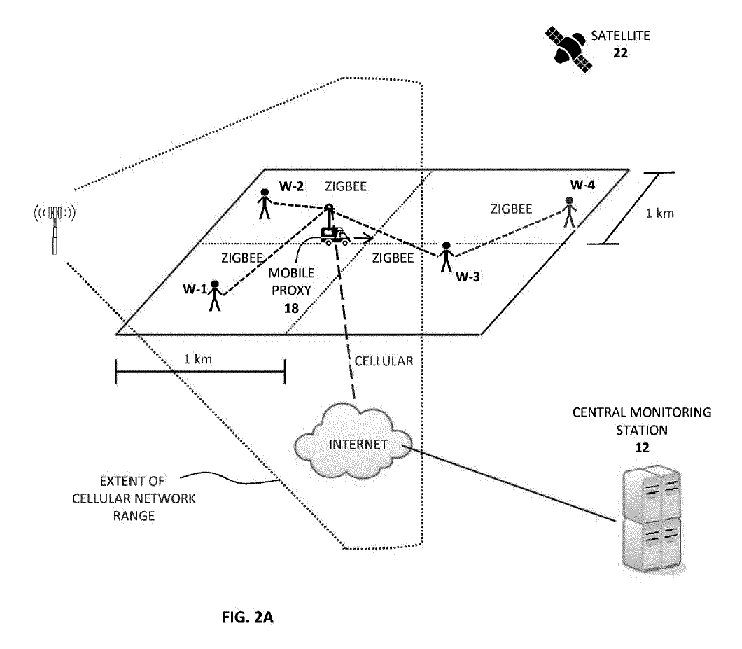

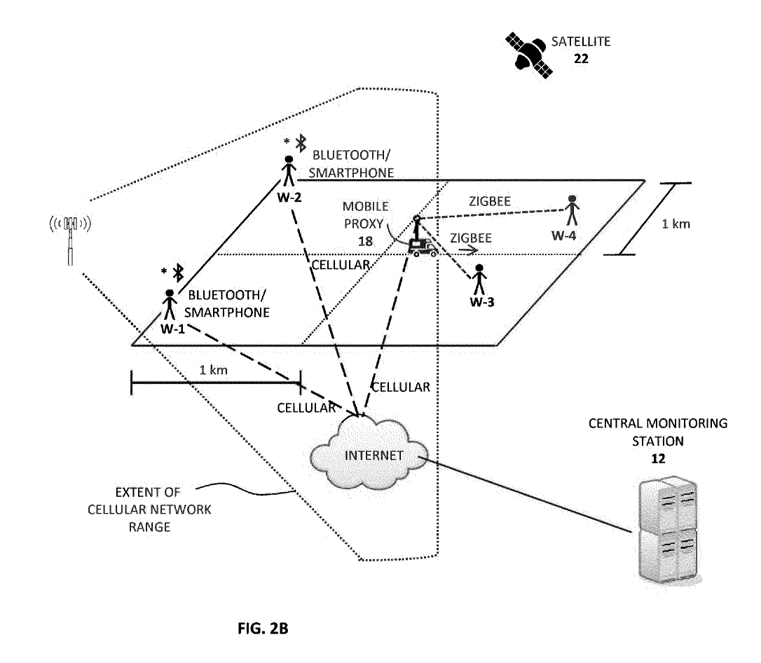

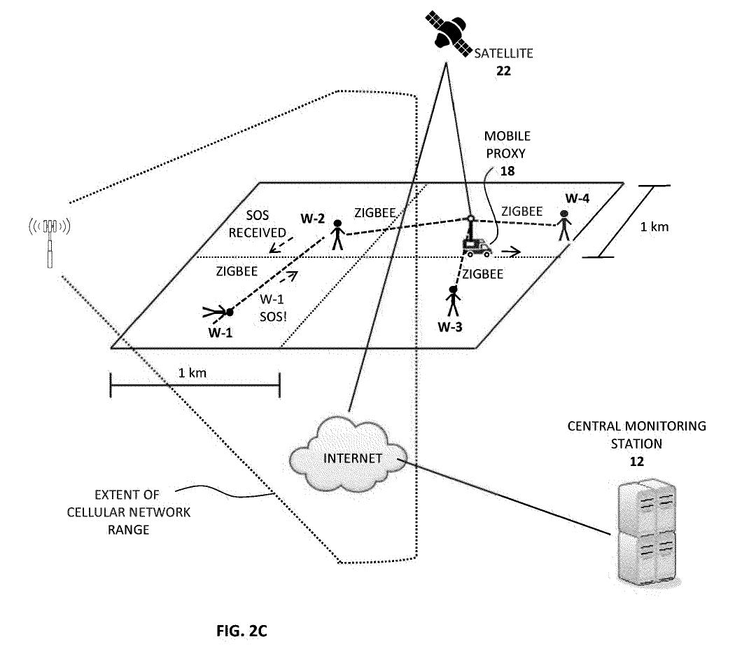

With reference to FIGS. 2A to 2C, this example describes monitoring of four different workers (W-1, W-2, W-3 and W-4) using the same variable composition network and safety pendant device described in Example 1. In FIGS. 2A to 2C, similar reference numbers are used to represent similar features.

In FIG. 2A, there is shown a 4-square kilometer work grid with one worker from among the group of workers (W-1, W-2, W-3 and W-4) working in each of the four quadrants of the work grid (which could be defined with reference to GPS coordinates, for example). Such a work grid could be defined on land and/or on water. Examples of potentially dangerous work activities being carried out on such a work grid could include controlling a forest fire, searching for a missing person, vehicle or boat, as well as work relating to harvesting of natural resources such as oil and gas well drilling, mining, fishing and forestry operations. Each of the four workers W-1, W-2, W-3 and W-4 carries a safety pendant (not shown), as well as a smartphone (not shown). The smartphone is configured to act as a messaging proxy device by having a smartphone application installed thereon for communicating with a safety pendant via Bluetooth and with the central monitoring station 12 via a cellular network and the internet. In FIG. 2A, the mobile messaging proxy 18 is located on the border between the two left quadrants and is approaching the center of the grid. The mobile messaging proxy 18 collects, stores, prioritizes and transmits data obtained from the four workers W-1, W-2, W-3 and W-4. In certain embodiments, the mobile messaging proxy also acquires data about its own location and speed and transmits this data if desired.

As described in Example 1, the safety pendant of each worker is capable of communicating with the mobile messaging proxy 18 using either Bluetooth or ZigBee radio and then the mobile messaging proxy 18 communicates with the central server 12 via a cellular network and the internet or a satellite network and the internet. In addition, the safety pendant can communicate via Bluetooth with the smartphone which acts as a backup messaging proxy device and sends the communication to the central monitoring station 12 via a cellular network and the internet.

In FIG. 2A, it is seen that worker W-1 is near the center of the front-left quadrant and is within ZigBee range of the mobile messaging proxy device 18. Since the mobile messaging proxy device 18 is within the cellular network range (indicated by the dotted polygon), worker W-1 makes a mobile messaging proxy device 18 connection to the central monitoring station 12 via the cellular network. The situation is similar for workers W-2 and W-3 (located respectively in the back-left and front-right quadrants) because they are both within the 1 kilometer range of the ZigBee communication mode of their respective safety pendants. The situation is different for worker W-4 who is located at the right boundary in the back-right quadrant, placing him out of ZigBee range with the mobile messaging proxy device 18. However, worker W-4 is within ZigBee mesh range of the safety pendant of worker W-3 and thus makes a link with the mobile messaging proxy device 18 via the safety pendant of worker W-3. All four of the workers W-1, W-2, W-3 and W-4 have thus maintained communication with the central monitoring station 12. The presence of a satellite 22 is shown in FIG. 2A, but it is not required because all of the workers W-1, W-2, W-3 and W-4 are able to connect to the central monitoring station 12 via the mobile messaging proxy device 18 and the cellular network.

In FIG. 2B, as in FIG. 2A, there is shown a 4-square kilometer work grid with one worker from among the group of workers (W-1, W-2, W-3 and W-4) working in each of the four quadrants of the work grid. The mobile messaging proxy device 18 remains on the border between the two left quadrants but has now moved toward the right side and has passed the center of the grid, placing it closer to workers W-3 and W-4 who both have changed their locations slightly in their respective quadrants. Workers W-3 and W-4 make direct ZigBee contact with the mobile messaging proxy device 18 and their communications are transmitted via the cellular network and the internet to the central monitoring station 12. However, the situation is different for workers W-1 and W-2 in the front-left and back-left quadrants, respectively. Since the mobile messaging proxy unit 18 has moved to the right, both of these workers W-1 and W-2 are now out of ZigBee contact range. However, they are within cellular network range (as indicated by the dotted polygon). As a result, their safety pendants each make a switch to Bluetooth and connect with the workers' respective smartphones which have a smartphone network application installed (the Bluetooth signal and the smartphone are indicated by the Bluetooth symbol and an asterisk, respectively). The smartphones both communicate with the central monitoring station 12 via the cellular network and the internet (the mobile messaging proxy device 18 is bypassed in this scenario for workers W-1 and W-2). In this scenario, the smartphones of workers W-1 and W-2 may be considered as messaging proxy devices which were initiated as backups. As noted in the description of FIG. 2A above, communication by satellite 22 is possible but is not used because less costly alternatives are available.

In FIG. 2C, as in FIGS. 2A and 2B, there is shown a 4-square kilometer work grid with one worker from among the group of workers (W-1, W-2, W-3 and W-4) working in each of the four quadrants of the work grid. The mobile messaging proxy unit 18 remains on the border between the two left quadrants but has now moved even further to the right and is now outside of cellular network range (as indicated by the dotted polygon). As a result, all communications to and from the mobile messaging proxy unit 18 must be transmitted via satellite 22. Worker W-1 has been involved in an accident in the front-left quadrant and transmits an SOS signal. Although he is outside of ZigBee range of the mobile messaging proxy unit 18, worker W-1 is within ZigBee mesh range of worker W-2. Therefore, the SOS transmission from the safety pendant of worker W-1 is passed via the ZigBee mesh network to the safety pendant of worker W-2 and then via ZigBee to the mobile messaging proxy unit 18 where it is transmitted via the satellite network and the internet to the central monitoring station 12. Workers W-2, W-3 and W-4 are each within ZigBee range and their communications are routed to the mobile messaging proxy unit 18 via ZigBee and then to the central monitoring station 12 via the satellite network and the internet.

### Example 3

### Five Different Network Combinations Selected by Processor Logic According to Cost and Availability

The network embodiments described in Examples 1 and 2 provide five different network component combinations when coupled to processor logic programmed to make communication mode selections according to cost and availability. The program logic will first determine if the most cost-effective communication modes are available and then select them in order to minimize cost and/or power requirements. For example, from the standpoint of communications from the mobile messaging proxy unit 18 to the central monitoring station 12 (and vice versa), the satellite network communications are the most costly and will only be selected in the absence of cellular network coverage. Likewise, from the standpoint of communications to and from the safety pendant, the pathway from the pendant to a smartphone via Bluetooth is not expensive, but the subsequent pathway to the central monitoring station 12 via a cellular network is relatively expensive and will be selected as a last resort in the absence of direct Bluetooth contact or direct (or indirect) ZigBee contact with the mobile messaging proxy unit 18. In addition, direct Bluetooth contact is less expensive than ZigBee contact and thus will be selected over ZigBee contact if both of these modes are available.

The five possible communications pathways for the embodiment of Examples 1 and 2 are outlined in Table 2 below.

TABLE 2
Communications Pathways Selected According to Cost and Availability

| Devices and | | | | | |
|---|---|---|---|---|---|
| Communication | | | | | |
| Mode Availability | Scenario 1 | Scenario 2 | Scenario 3 | Scenario 4 | Scenario 5 |
| From Pendant: | yes | No | no | yes | no |
| Bluetooth | | | | | |
| Available? | | | | | |
| From Pendant: | yes | Yes | no | yes | yes |
| ZigBee Available? | | | | | |
| From Pendant: | yes | Yes | yes | yes | yes |
| Smartphone + | | | | | |
| Cellular Network | | | | | |
| available? | | | | | |
| From Messaging | yes | Yes | yes | no | no |
| proxy: Cellular | | | | | |
| Network | | | | | |
| Available? | | | | | |
| From Messaging | yes | Yes | yes | yes | yes |
| Proxy: Satellite | | | | | |
| Available (always | | | | | |
| yes) | | | | | |
| Network Pathway | Pendant- | Pendant- | Pendant- | Pendant- | Pendant- |
| Selected by | Bluetooth- | ZigBee- | Bluetooth- | Bluetooth- | ZigBee- |
| Processor Logic: | Messaging | Messaging | Smartphone- | Messaging | Messaging |
| | Proxy- | Proxy- | Cellular- | Proxy- | Proxy- |
| | Cellular- | Cellular- | Monitor | Satellite- | Satellite- |
| | Monitor | Monitor | | Monitor | Monitor |

It will be understood from the foregoing description that scenarios 1 to 5 are ranked from the least costly to the most costly and would be selected in that order according to communication mode availability. The program logic required to make the selections can be developed and incorporated into the safety pendant and messaging proxy device without undue experimentation. These five scenarios relate to the example embodiment described with respect to FIGS. 1 and 2. It is to be understood that different scenarios will be applicable in alternative embodiments wherein the safety pendant and/or the messaging proxy device(s) is/are provided with hardware which enables additional communication modes.

### Example 4

### Registration of a Specific Safety Pendant to a Specific Worker and Informed Rescue of the Specific Worker

This example illustrates how a specific safety pendant can be registered to a specific worker and how the specific worker's medical information can be obtained from a medical database and linked to the worker via the central monitoring station for transmission to emergency medical personnel.

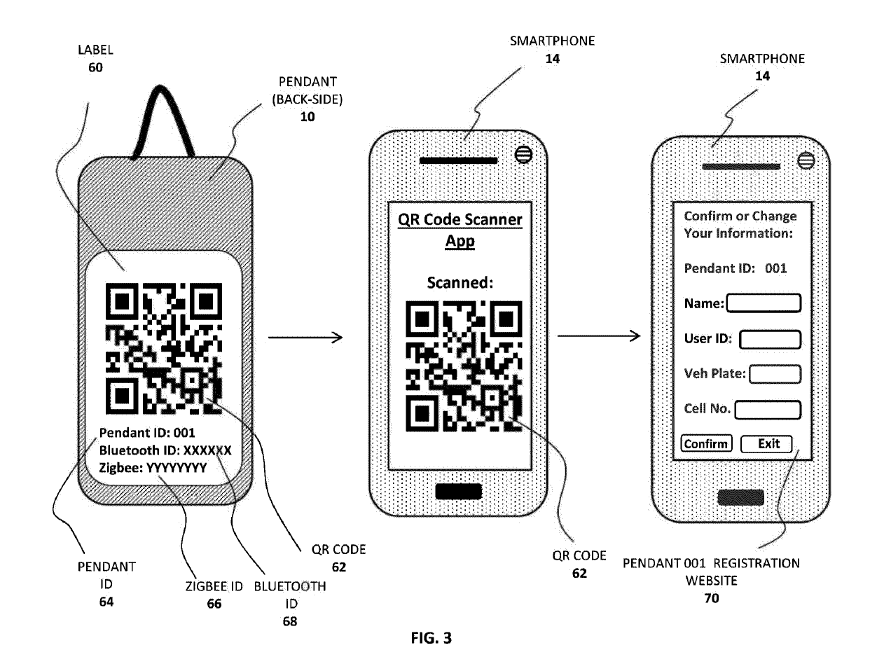

FIG. 3 shows a process by which a code scanner on a smartphone 14 is used to link to a website for registration of a specific safety pendant 10 with ID 001 to a user. The back side of the pendant 10 has a label 60 affixed thereto. Advantageously, the label is protected with clear plastic or tape to prevent damage while the pendant 10 is in use. The label 60 includes a QR code 62, and additional identifying information for the pendant 10 including a pendant ID number 64, ZigBee ID number 66, and a Bluetooth ID number 68. Advantageously in certain embodiments, the QR code includes metadata relating to the specific safety pendant. As understood by the skilled person, metadata is data about data and more specifically in the present case, data relating to a specific device, such as, for example, the model number and the serial number. This allows the smartphone's web browser to open a page specific for the individual device being registered. The QR code 62 is scanned using a QR code scanner application on the smartphone 14. Such QR code scanners are known in the art, some of which may be downloaded from an application server at no cost to the user. In addition, QR code generators are available to the public at no cost on the internet. Thus, a QR code representing the URL of a specific website linked to pendant 001 can be generated and used to point a mobile device to that website when the QR code 62 is scanned. When this is done, the QR code scanning application triggers the opening of a website 70 on the smartphone 14. In this particular example, four fields are available on the website 70 for an individual user to enter user information including name, user ID, vehicle plate number, and cellular telephone number, as well as the options to confirm the information and exit the website. The skilled person will recognize that although this example describes a smartphone and a QR code, other alternatives are possible such as alternative bar codes or the use of a tablet, laptop, or other mobile computing device instead of a smartphone. Other types of identifying information may be entered on the website in alternative embodiments. The skilled person will also recognize that while this example is focused on registration of a safety pendant to an individual, the method is applicable for registration of other mobile communication devices which may be shared among team members. Examples include one-way and two-way communication devices used to locate individuals such as the commercially available devices known as inReach™ and SPOT™ which use satellite communication networks.

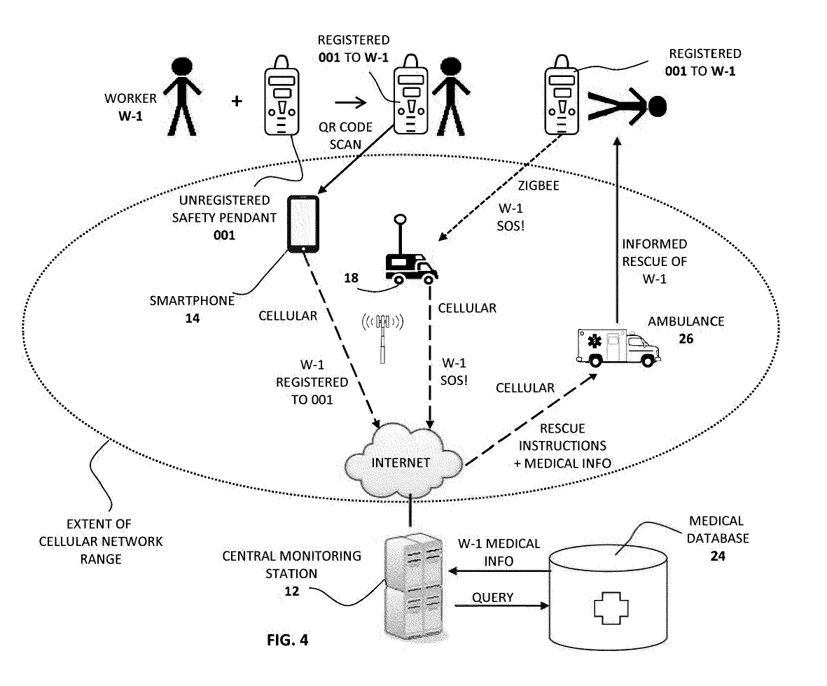

FIG. 4 illustrates how registration of a specific safety pendant to a specific worker can facilitate an informed rescue of the registered worker in the event of an accident.

In this example, worker W-1, uses his smartphone 14 to register himself as the user of pendant ID number 001 by using a QR code scanner on the smartphone 14 to open a website on the smartphone 14 where he enters his identifying information (as shown, for example, in FIG. 3). The central monitoring station 12 gains access to the website over a VPN and stores the registration information of worker W-1. Some time after registration, Worker W-1 is carrying pendant 001 while he is working at a worksite and is involved in an accident. He then uses pendant 001 to transmit an SOS message to the central monitoring station 12 via the mobile messaging proxy unit 18 and a cellular network (via VPN). The central monitoring station 12 receives the SOS message and transmits a confirmation message (not shown, in the interest of preserving clarity). Next, the central monitoring station 12 uses the pendant 001 registration information (linked to worker W-1) to query a medical database 24 (which may be provided as a module at the central monitoring station 12) for relevant medical information pertaining to worker W-1. The medical database 24 then provides the information to the central monitoring station 12. In this particular example, the medical information provided by the medical database includes two important details: (i) the blood type of worker W-1 is the rare type AB-negative, and (ii) worker W-1 is currently using blood thinning medication. This information in addition to other routine medical information is transmitted to the emergency medical technicians with the instructions to travel to the worksite in a rescue vehicle 26 to rescue and treat worker W-1. Because the emergency medical technicians were provided with important medical information, they are able to ensure that an adequate supply of AB-negative blood is on hand for a transfusion, if needed. The skilled person will recognize that many other classes of medical information about an injured worker will be very helpful in such emergency situations. Likewise, the central monitoring station will have access to emergency contact information pertaining to the worker so that his family can be promptly informed of the accident.

### Example 5

### Reporting of Safety Pendant Location Information under Different Network Connectivity Scenarios

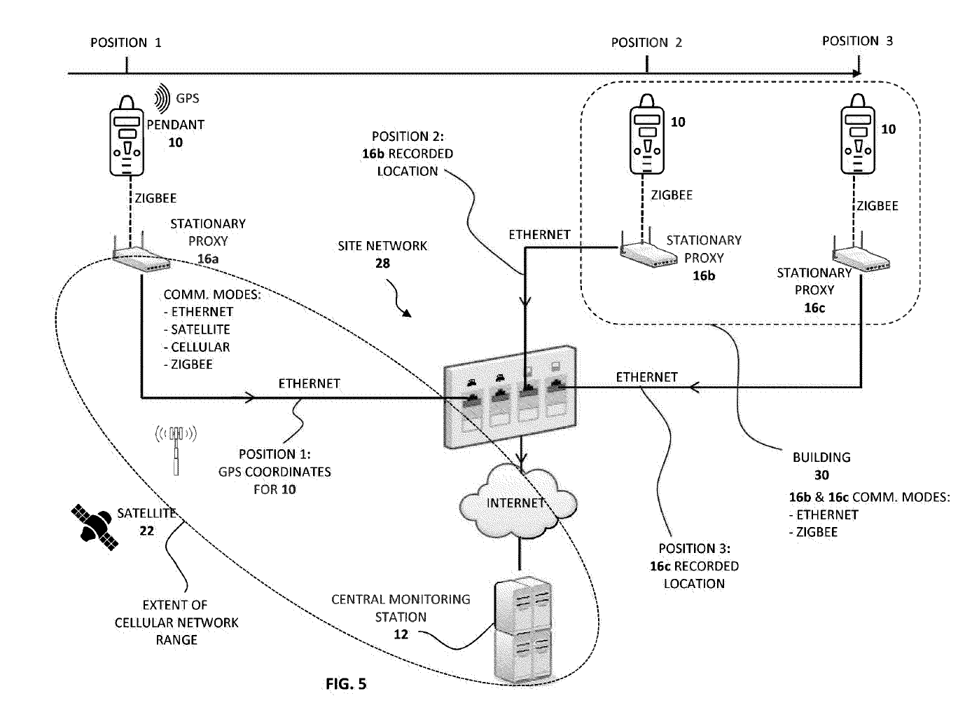

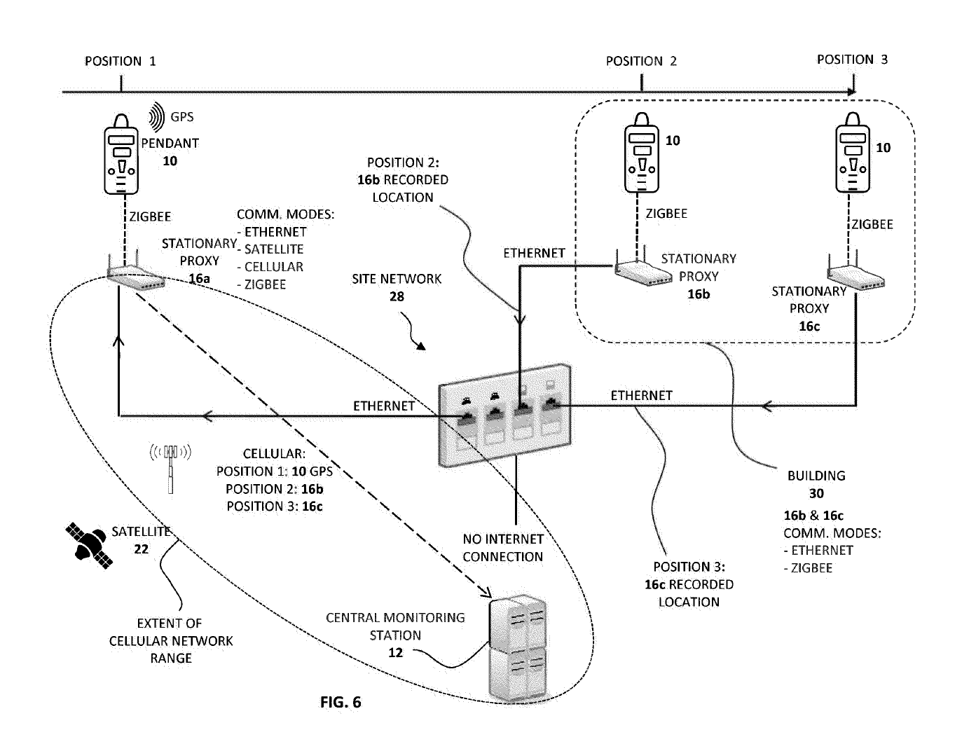

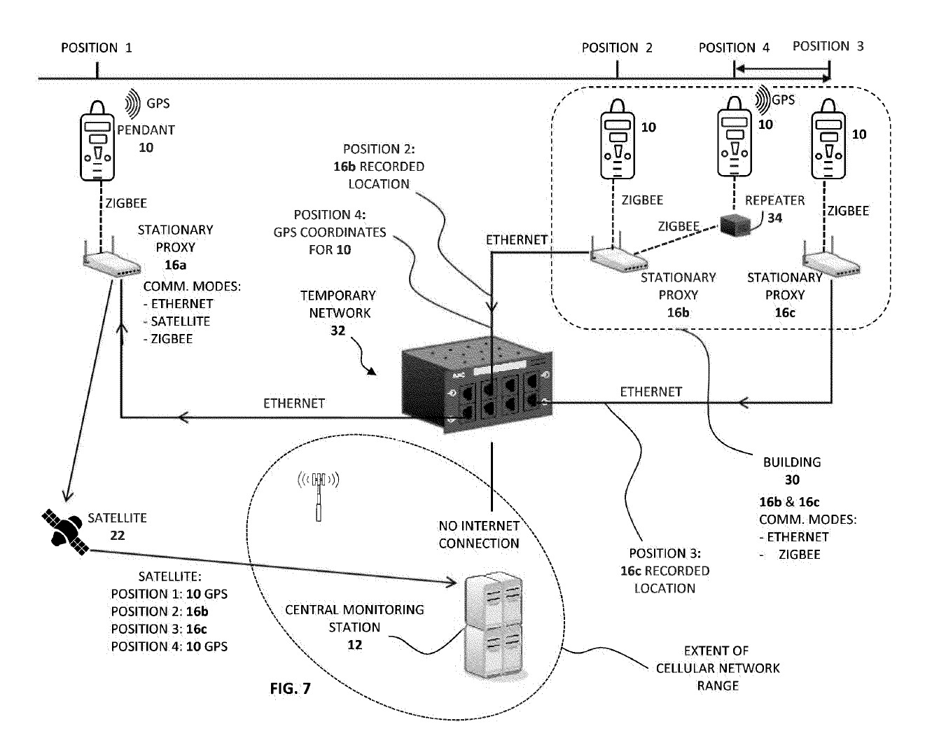

Shown in FIGS. 5 to 7 are schematic network representations indicating how safety pendant location information is determined and transmitted to the central monitoring station under different network connectivity scenarios, each of which includes a hard-wired network component which may be a permanent site network (FIGS. 5 and 6) or a temporary network (FIG. 7). In this particular example, a single safety pendant 10 carried by a user to different positions is being followed sequentially by three different messaging proxy devices at different locations at a hydroelectric dam facility. Stationary messaging proxy 16a is outside and stationary messaging proxy 16b and 16c are located within a building 30 at the facility.

In each of the three scenarios described in this example, the three different stationary messaging proxy devices 16a, 16a and 16c are used to transmit location information for the safety pendant 10. These three stationary messaging proxy devices 16a, 16a and 16c are permanently or semi-permanently installed for the purpose of monitoring workers carrying safety pendants as they move around the facility. This includes movement outdoors and within various buildings at the facility. Such safety monitoring is required because various safety hazards exist with respect to outdoor and indoor equipment employed at the facility. The network for safety monitoring is conveniently accomplished when a pre-existing site network 28 with Ethernet ports is available (FIGS. 5 and 6).

In each of the three scenarios (FIGS. 5-7), safety pendant positions 1, 2 and 3 remain consistent and safety pendant position 4 is shown only in FIG. 7. In addition, all communications originating from pendant 10 are transmitted via Zigbee. The main differences among these scenarios are the availability of modes of communication of the stationary messaging proxy devices 16a, 16a and 16c with respect to transmission of status messages to the central monitoring station 12. Additional differences exist in the scenario depicted in FIG. 7 and will be described below.

Turning now to FIG. 5, there is shown a site network 28 which includes three stationary messaging proxy devices 16a, 16a and 16c. Each one of the stationary messaging proxy devices 16a, 16a and 16c is strategically located for the purpose of monitoring the safety of workers carrying safety pendants. The site network 28 comprises Ethernet connections from the stationary messaging proxy devices 16a, 16a and 16c to the central monitoring station 12 via the internet. When safety pendant 10 is located at outdoor position 1 (200 m due east of the facility's helicopter landing pad), its GPS receiver picks up its GPS coordinates and these GPS coordinates are transmitted to stationary messaging proxy 16a (installed in a shed near the helicopter landing pad) via Zigbee and then transmitted to the central monitoring station 12 via the site network 28 and the internet. When the worker carrying safety pendant 10 moves to position 2, inside a large building 30 which has no GPS access at most locations therein, pendant 10 is unable to report GPS coordinates and is therefore (by default) assigned the zone location of stationary messaging proxy device 16b which is pre-loaded into the memory of the device 16b. In this particular example, the zone location transmitted to the central monitoring station via messaging proxy 16b, the site network 28 and the internet indicates “building 6: 4^{th} level of turbine wing” Therefore, if the user of pendant 10 is involved in an accident at position 2 and triggers an emergency status signal on pendant 10, the central monitoring station 12 will provide instructions to the rescue crew to search for the user in building 6 on the 4^{th} level of the turbine wing. Continuing with this example, if the user of pendant 10 now attempts a self-rescue and moves from position 2 to position 3 (1^{st} level of the turbine wing, a location which also has no GPS access), the central monitoring station 12 would receive this position information from stationary messaging proxy 16c via a pathway including the site network 28 Ethernet connections and the internet. The location of pendant 10 reported to the central monitoring system 12 is “building 6: 1^{st} level of turbine wing.” This message would then be relayed to the rescue team. It is to be understood that in the scenario shown in FIG. 5, the communication modes available for stationary messaging proxy 16a include Ethernet (to other messaging proxy devices and to internet), cellular, satellite and Zigbee, the Ethernet connection to the internet is selected by the communication mode selection algorithm programmed into device 16a because it provides the most cost-effective transmission of status messages to the central monitoring station 12. Other possible network compositions are possible, and are described below with reference to FIGS. 6 and 7.

Turning now to FIG. 6, there is shown a similar scenario of movement of a user carrying a safety pendant 10 from position 1 to position 2 and then to position 3. However, in this scenario there is no internet connection, as a result of a failure of equipment operated by the internet service provider. Although the internet connection is disrupted in this scenario, the stationary messaging proxy devices 16a, 16a and 16c remained networked to each other via the Ethernet connections of the site network 28. Stationary messaging proxy device 16a is the only messaging proxy device which is connectable to a cellular network (shown by the dashed oval in FIG. 6). Thus position 1 (GPS coordinates of pendant 10 at location 1) is transmitted from stationary messaging proxy 16a via the cellular network to the central monitoring station 12. Positions 2 and 3 do not have direct access to the cellular network or to the satellite network because they are located inside the building 30. As indicated in FIG. 6, the only communication modes available for stationary messaging proxy devices 16b and 16c are Ethernet and Zigbee. Therefore, the communication mode selection algorithm of both of these devices 16b and 16b selects the Ethernet mode and transmits the pre-recorded locations of devices 16b and 16c to device 16a. Device 16a then collects this location information and transmits these locations (4^{th} floor and 1^{st} floor of turbine wing of building 6, respectively) to the central monitoring station 12 via the cellular network. Thus all communications are routed to the central monitoring station 12 via device 16a and the cellular network. It is to be understood that a satellite network is also available but is not selected by the communication mode selection algorithm because the cellular network is available at device 16a and because satellite network transmissions are more costly than cellular network transmissions.

Turning now to FIG. 7, there is shown another scenario indicating movement of a user carrying a safety pendant 10 from position 1 to position 2 to position 3, and then an additional backtracking movement to position 4. One additional difference in FIG. 7 is that a temporary network 32 is shown which employs an ethernet switch which allows an ethernet network to be quickly installed and removed later if desired. In keeping with the worker movement scenarios described above, position 4 represents an additional movement of the user carrying pendant 10. During the course of self-rescue, the user carrying pendant 10 reverses course and moves from the first level to the second level of the turbine wing of building 6 and approaches a large window. Pendant 10 then acquires a GPS signal through the window and receives GPS coordinates for position 4. The second level of the turbine wing of building 6 (which includes position 4) lacks a messaging proxy device. However, there is a signal repeater 34 which receives the location status indicating position 4 with GPS coordinates and the signal repeater 34 is within range of device 16b. Thus position 4 is transmitted via device 16b and via the Ethernet of the temporary network to device 16a. Likewise, position 2 is transmitted via device 16b and via the Ethernet of the temporary network to device 16a and position 3 is transmitted via device 16c and via the Ethernet of the temporary network 32 to device 16a. In this scenario, the cellular network is disrupted and therefore, the satellite communication mode is selected by the communication mode selection algorithm of device 16a. The four sequential positions of pendant 10 are transmitted from device 16a to the central monitoring system 12 via the satellite network.

### Example 6

### Prioritization and Transmission of Sensor-Based Messages

In this example embodiment, three stationary diesel-powered generators at various locations are monitored by a central monitoring station via a network which includes different message transmission modes.

Generator A is located in an urban area in close proximity to a Wi-Fi network. Generator B is located in a rural area which has cellular network coverage. Generator C is located in a remote area without cellular network coverage. It is desirable to monitor the fuel level, temperature and oil pressure of the generator while it is working. A sudden drop in oil pressure or a sudden increase in temperature may indicate that a major malfunction is imminent. Likewise, other parameters relating to operation of the generators may be monitored.

The generator sensors are connected to a messaging proxy device which has a message generator configured to receive the sensor output data and convert the output data to messages. The messaging proxy device also has a storage module for storing and prioritizing the messages for transmission to a central monitoring station by one or more of a plurality of message transmission modes, with prioritization of each message assigned according to the urgency of the message and the cost of each of the transmission modes. The prioritization is performed using an algorithm which may be programmed by the skilled person without undue experimentation. The messaging proxy device is also provided with an internal network conduit for receiving messages from the storage module and transmitting messages by one or more of a satellite network modem, a cellular network modem and a WiFi modem, according to the prioritization of each message.

In this embodiment, the storage module is configured to allow changes to the prioritization of each message to be programmed remotely from the central monitoring station. Among the lower priority messages, the prioritization is set to prevent transmission of the message until a low cost transmission mode becomes available. The messaging proxy may also be set to retain and store certain sets of data for manual upload to portable media such as a USB stick, with no transmission under any circumstances.

The different messaging processes for the three generators under an identical set of sensor outputs will now be described. The sensor outputs include a low priority fuel gauge indication that the fuel tank is half-empty; a mid-priority indication that the generator temperature is 20% higher than normal; and a high priority indication that the oil pressure has dropped by 50%, indicating a malfunction. It is to be understood that additional messages may be generated from different thresholds of data and prioritized accordingly.

Generator A in the urban environment is connected to a Wi-Fi network via a Bluetooth connection. This arrangement is the lowest cost transmission mode and therefore, messages are generated for all three examples of sensor output from the generator and subsequently routed by the messaging proxy to the central monitoring station via the internet. In addition, the high priority oil pressure message is immediately transmitted via all three transmission modes (Internet, cellular and satellite) in order to provide redundancy in the event of failure of one or more of the transmission modes.

Generator B in the semi-rural area has access to a cellular network but is not accessible to the internet. Cellular network transmissions are more costly and therefore it is beneficial to restrict messaging to mid- and high-level priority messages. The messaging proxy stores the low priority fuel level message but does not transmit it. It transmits both the temperature and oil pressure messages by the cellular network (mid and high priority messages). In addition, the oil pressure message is immediately transmitted via all three transmission modes (Internet, cellular and satellite) in order to provide redundancy in ensuring that the high priority message is received.

Generator C in the remote area does not have access to the internet or to a cellular network. The only available mode for transmission of messages is via the satellite network. As such, the low- and mid-priority fuel level and temperature messages are stored and not transmitted in order to provide cost savings. The oil pressure message is transmitted via the satellite network.

In this example, the messaging proxy is configured such that the prioritization rules may be changed remotely by a controller at the central monitoring station. Continuing with the present example, near the end of the month, the controller reviews the cellular network usage for the month and notes that the network has not used most of its data allotment provided under contract with the cellular network provider. The controller then re-programs the cost-weighted decision algorithm (prioritization algorithm) to change the prioritization of the 50% fuel level message as mid-priority so that any future 50% fuel level messages will be transmitted by the cellular network (whereas prior to re-programming, they were classified as low priority and only transmitted via the internet, if available). Thus more data can be received for analysis without incurring additional cost.

The skilled person will recognize that other types of equipment or vehicles can be monitored in a similar matter with transmission of messages relating to essentially any data which may be of interest. With regard to vehicles, data output from sensors may be provided by the specialized internal communications network that interconnects components inside a vehicle (vehicle bus).

### EQUIVALENTS AND SCOPE

Although the present invention has been described and illustrated with respect to preferred embodiments and preferred uses thereof, it is not to be so limited since modifications and changes can be made therein which are within the full, intended scope of the invention as understood by those skilled in the art. Each of the references cited herein is incorporated herein by reference in entirety.

1. A network for providing mobile personnel safety status, the network comprising:
a) a safety pendant including hardware configured to provide a plurality of pendant communication modes for transmitting a status message, wherein a most costly pendant communication mode of the plurality of pendant communication modes is selected when no other communication mode of the plurality of pendant communication modes is available and wherein a least costly pendant communication mode of the plurality of pendant communication modes is selected whenever it is available;
b) a messaging proxy device including hardware configured to provide one or more proxy communication modes for transmitting the status message, wherein, if the messaging proxy device provides more than one proxy communication mode of the one or more proxy communication modes, the messaging proxy device includes an algorithm for prioritizing the proxy communication modes according to an availability and a cost of transmission with selection of a most costly proxy communication mode of the one or more proxy communication modes when no other proxy communication mode of the one or more proxy communication modes is available and selection of a least costly proxy communication mode whenever it is available; and
c) a central monitoring station for receiving the status message transmitted from the messaging proxy device.

2. The network of claim 1, wherein the messaging proxy device is a smartphone which is connectable to a cellular network as an only proxy communication mode of the one or more proxy communication modes used for transmitting the status message to the central monitoring station.

3. The network of claim 1, wherein the messaging proxy device is a wireless asset management (WAM) hub which is configured to provide a plurality of proxy communication modes of the one or more proxy communication modes for transmitting the status message to the central monitoring station.

4. The network of claim 3, wherein the one or more proxy communication modes includes two or more of a satellite communication mode, a cellular communication mode, an Ethernet communication mode and a Wi-Fi communication mode.

5. The network of claim 1, wherein the messaging proxy device is located in and operated from a vehicle.

6. The network of claim 1, wherein the pendant communication modes include any combination of two or more of: Bluetooth, Ethernet, access point Wi-Fi, radio, cellular and satellite communication modes.

7. The network of claim 6 wherein the pendant communication modes are Bluetooth and a radio communication mode.

8. The network of claim 7 wherein the radio communication mode is ZigBee radio.

9. The network of claim 1, wherein the safety pendant includes a GPS or GLONASS receiver, or both, and the status message includes safety pendant location information, determined by the GPS or GLONASS receiver or both.

10. The network of claim 1, wherein the safety pendant includes a gyrometer and the status message includes safety pendant orientation information determined by the gyrometer.

11. The network of claim 1, wherein the safety pendant includes an accelerometer and the status message includes safety pendant acceleration information determined by the accelerometer.

12. The network of claim 1, wherein the messaging proxy device includes a data storage module and a processor configured to store low priority messages in the data storage module for later transmission when a lower-cost communication mode becomes available.

13. The network of claim 1, which is configured for two-way communication between the safety pendant and the central monitoring station via the messaging proxy device.

14. A network for monitoring equipment or vehicles, the network comprising:
a) a messaging proxy device including hardware configured to provide one or more proxy communication modes for transmitting a status message based on data received from the equipment or vehicles, wherein the messaging proxy device includes an algorithm for prioritizing the proxy communication modes according to an availability and a cost of transmission with selection of a most costly proxy communication mode when no other proxy communication mode is available and selection of a least costly proxy communication mode whenever it is available; and
b) a central monitoring station for receiving a status message transmitted from the messaging proxy device.

15. The network of claim 14, wherein the messaging proxy device is a wireless asset management (WAM) hub which is configured to provide a plurality of proxy communication modes for transmitting the status message to the central monitoring station.

16. The network of claim 15, wherein the plurality of proxy communication modes includes two or more of a satellite communication mode, a cellular communication mode, an Ethernet communication mode and a Wi-Fi communication mode.

17. The network of claim 14, wherein the messaging proxy device is located in and operated from a vehicle.

18. The network of claim 14 further comprising a safety pendant including hardware configured to provide a plurality of pendant communication modes for transmitting the status message, wherein a most costly pendant communication mode is selected when no other communication mode is available and wherein a least costly pendant communication mode is selected whenever it is available.

19. The network of claim 18, wherein the pendant communication modes include any combination of two or more of: Bluetooth, Ethernet, access point Wi-Fi, radio, cellular and satellite communication modes.

20. The network of claim 18, wherein the pendant communication modes are Bluetooth and a radio communication mode.

21. The network of claim 20, wherein the radio communication mode is ZigBee radio.

22. The network of claim 18, wherein the safety pendant includes a GPS or GLONASS receiver, or both, and the status message includes safety pendant location information, determined by the GPS or GLONASS receiver or both.

23. The network of claim 18, wherein the safety pendant includes a gyrometer and the status message includes safety pendant orientation information determined by the gyrometer.

24. The network of claim 18, wherein the safety pendant includes an accelerometer and the status message includes safety pendant acceleration information determined by the accelerometer.

25. The network of claim 14, wherein the messaging proxy device includes a data storage module and a processor configured to store low priority messages in the data storage module for later transmission when a lower-cost communication mode becomes available.

26. The network of claim 14, which is configured for two-way communication between the safety pendant and the central monitoring station via the messaging proxy device.

27. The network of claim 14, wherein the algorithm for prioritizing the proxy communication modes is re-programmable by a programmer when remotely connected to the messaging proxy device.

28. A safety pendant for providing mobile personnel status, the safety pendant comprising:
a) hardware configured to provide a plurality of communication modes;
b) a user interface configured to allow an input of a plurality of status states and to display messages transmitted from a central monitoring station; and
c) a processor configured to select a pendant communication mode from the plurality of communication modes based on availability and cost wherein a most costly pendant communication mode is selected when no other pendant communication mode is available and wherein a least costly pendant communication mode is selected whenever it is available.

29-57. (canceled)
